(19) United States
(12) Patent Application Publication
(10) Pub. No.: US 2010/0183078 A1
(43) Pub. Date: Jul. 22, 2010

(54) APPARATUS AND METHOD FOR KEEPING BIT RATE OF IMAGE DATA

(76) Inventors: Hyoung Jin Kwon, Chungcheongbuk-do (KR); Hyunsang Park, Chungcheongnam-do (KR); Woo Yong Lee, Daejeon (KR); Jin Kyeong Kim, Daejeon (KR); Kyeongpyo Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/669,819

(22) PCT Filed: Aug. 21, 2008
(86) PCT No.: PCT/KR08/04866

§ 371 Date: Jan. 20, 2010

(30) Foreign Application Priority Data
Aug. 28, 2007 (KR) 10-2007-0086771
Mar. 7, 2008 (KR) 10-2008-0021373

(51) Int. Cl. H04N 7/12

(52) U.S. Cl. 375/240.25; 375/240.01; 375/E07.076; 375/E07.027

(57) ABSTRACT

An apparatus for uniformly maintaining a bit rate of image data includes an image encoding apparatus including: a bit shifter configured to shift a predetermined number of bits included in line pixel data of a single line; an encoder configured to compress the bit shifted line pixel data and output a compressed bitstream; and a data frame formatter configured to generate a data frame including a bit shift field, the bit shift field containing information associated with the shifted bit of the pixel data, and an image decoding apparatus including: a data frame deformatter configured to receive a data frame and extract a field value from the data frame; a decoder configured to decode a compressed bitstream from the data frame, and recover line pixel data; a bit shifter configured to shift a predetermined number of bits; and a bit recovery unit configured to recover a lost bit.

### TECHNICAL FIELD

The present invention relates to an apparatus and method of uniformly maintaining a bit rate of image data, and more particularly, to an apparatus and method of uniformly maintaining a bit rate of image data in a wireless environment.

This work was supported by the IT R&D program of MIC/IITA. [2007-S-002-01, Development of Multi-Gigabit Air Interface Technology]

### BACKGROUND ART

When transmitting image data via a channel with limited bandwidth, a bit rate of the image data needs to be uniformly maintained for real-time transmission. However, due to characteristics of the image data, an encoding bit rate may change, which may change the bit rate. Generally, a rate control scheme may be used to uniformly maintain the bit rate. However, since the rate control scheme performs lossy compression, there is a disadvantage in that the picture quality of a video may be deteriorated. In particular, since the deterioration phenomenon stands out in a high definition (HD) image, a viewer may feel uncomfortable with viewing the original image as is. Also, when transmitting image data in a wireless environment, characteristics of a radio channel may change over time with the limited bandwidth and thereby compression needs to be performed within the range where the picture quality is not deteriorated. Therefore, a lossless compression scheme may be performed. However, even in this case, since the bit rate changes due to characteristics of image data, it may be difficult to generate and transmit a uniform packet.

### DISCLOSURE OF INVENTION

### Technical Problem

An aspect of the present invention provides an apparatus and method of uniformly maintaining a bit rate of image data that can compress image data for each line according to characteristics of the image data and a channel, and transmit the compressed image data and thereby can uniformly maintain a bit rate of the image data.

The present invention is not limited to the above purposes and other purposes not described herein will be apparent to those of skill in the art from the following description.

### Technical Solution

According to an aspect of the present invention, there is provided an image encoding apparatus including: a bit shifter configured to shift a predetermined number of bits included in line pixel data of a single line; an encoder configured to compress the bit shifted line pixel data and output a compressed bitstream; and a data frame formatter configured to generate a data frame including a bit shift field, the bit shift field containing information associated with the shifted bit of the pixel data.

According to another aspect of the present invention, there is provided an image decoding apparatus including: a data frame deformatter configured to receive a data frame and extract a field value from the data frame; a decoder configured to decode a compressed bitstream from the data frame, and recover line pixel data; a bit shifter configured to shift a predetermined number of bits included in the line pixel data; and a bit recovery unit configured to recover a lost bit with respect to an output signal of the bit shifter.

According to still another aspect of the present invention, there is provided a method of encoding an image, the method including: adjusting a resolution of line pixel data of a single line; compressing the line pixel data with the adjusted resolution to output a compressed bitstream; generating a data frame including the bitstream; and transmitting the generated data frame.

According to yet another aspect of the present invention, there is provided a method of decoding an image, the method including: receiving a data frame to extract a field value from the data frame; decoding a compressed bitstream from the data frame to recover line pixel data; recovering a resolution of the line pixel data; and recovering a lost bit with respect to the line pixel data with the recovered resolution.

### BRIEF DESCRIPTION OF THE DRAWINGS

FIG. 1 is a block diagram illustrating a configuration of an image encoding apparatus according to an embodiment of the present invention;

FIG. 2 illustrates a format of a data frame in which each line of an image is compressed according to an embodiment of the present invention;

FIG. 3 is a block diagram illustrating a configuration of an image decoding apparatus according to an embodiment of the present invention;

FIG. 4 is a flowchart illustrating an image encoding method according to an embodiment of the present invention; and

FIG. 5 is a flowchart illustrating an image decoding method according to an embodiment of the present invention.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

The basic principle of the present invention is to compress image data for each line according to characteristics of the image data and a channel, and transmit the compressed image data and thereby to uniformly maintain a bit rate of the image data.

For example, an image encoding/decoding apparatus may uniformly maintain the bit rate of image data.

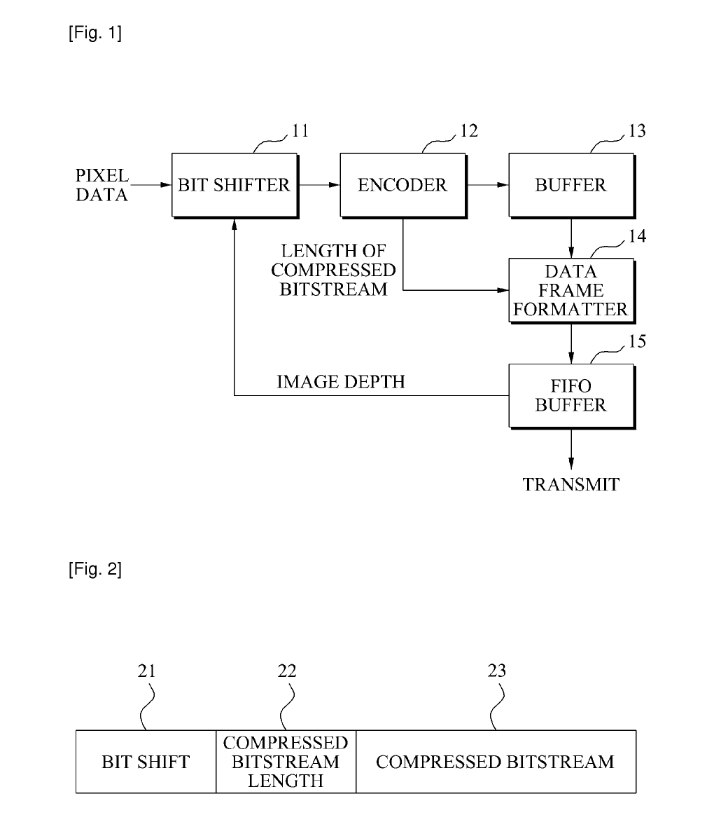

FIG. 1 is a block diagram illustrating a configuration of an image encoding apparatus according to an embodiment of the present invention.

Referring to FIG. 1, the image encoding apparatus includes a bit shifter 11, an encoder 12, a buffer 13, a data frame formatter 14, and a first in first out (FIFO) buffer 15. The image encoding apparatus may process image data for each line pixel unit. The line pixel indicates 3072 Red-Green-Blue (RGB) sub pixels corresponding to 1024 pixels of the horizontal line in, for example, a 1024×768 image.

The bit shifter 11 may adjust the resolution of pixels. Specifically, the bit shifter 11 may shift, to the right, a predetermined number of bits included in a line based on an image depth to be adjusted and thereby reduce the resolution of pixels. In this instance, the image depth may be a number of bits that can classify each color according to the saturation.

When line pixel data received by the bit shifter 11 consists of 7 bits, the line pixel data may be image data of which the image depth is 7 and that indicates one of saturation indexes divided into 128 steps. When reducing the image depth of the line pixel data from 7 to 5, the bit shifter 11 may shift the 7-bit line pixel data two bits to the right. In this case, 5-bit line pixel data may be output from the bit shifter 11 and the output line pixel data may have the image depth of 5. As described above, the bit shifter 11 may reduce the image depth and thereby reduce the resolution of pixels.

Also, the bit shifter 11 may assign a different resolution for each color. Since the eye sensitivity is different for each color, the bit shifter 11 may adjust the resolution of each color and thereby providing an improved image. For example, in comparison to red or blue, when green is lost, the eye may be more sensitive to green. Therefore, the bit shifter 11 may increase the resolution of green to be greater than the resolution of red or blue. Through this, the bit shifter 11 may enable fine adjustment with respect to the image.

The encoder 12 may receive line pixel data of a single line with the adjusted resolution and output a compressed bitstream to the buffer 13. The encoder 12 may receive line pixel data of a plurality of lines. The encoder 12 may output the length of the compressed bitstream to the data frame formatter 14. The encoder 12 may be a lossless encoder, but the present invention is not limited thereto. Specifically, the encoder 12 may be a lossy encoder with a relatively less loss.

The buffer 13 may receive the compressed bitstream from the encoder 12 to transfer the received bitstream to the data frame formatter 14 for each line unit.

The data frame formatter 14 may receive an output signal of the encoder 12 and the buffer 13 to generate a data frame. The data frame includes a bit shift field, a compressed bitstream length field, and a compressed bitstream field.

The FIFO buffer 15 may be a buffer that is configured to performing FIFO. The FIFO buffer 15 may output the compressed bitstream to a transmitting end. In order to uniformly maintain transmission data, the FIFO buffer 15 may determine an image depth based on a bitstream amount of line pixel data of a previous line and a remaining bitstream amount after transmitting the bitstream of the line pixel data of the previous line. Also, the FIFIO buffer 15 may transfer the image depth to the bit shifter 11.

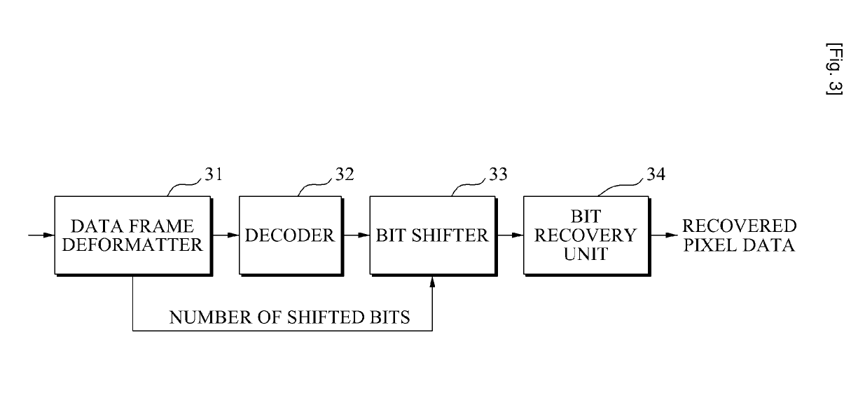

FIG. 2 illustrates a format of a data frame in which each line of an image is compressed according to an embodiment of the present invention.

Referring to FIG. 2, the data frame includes a bit shift field 21, a compressed bitstream length field 22, and a compressed bitstream field 23.

The bit shift field 21 indicates a bit-shifted level of line pixel data of a current line, that is, a number of shifted bits. Specifically, the bit shift field 21 indicates a predetermined number of bits that are shifted to the right among total bits of original line pixel data in order to adjust a predetermined transmission bit rate. The bit shift field 21 may be four bits. The bit shift field 21 indicates an adjusted bit of zero through 15. For example, when changing 7-bit line pixel data classified into 128 steps to 5-bit line pixel data classified into 32 steps, the original line pixel data may be shifted two bits to the right. In this case, the bit shift field 21 may be indicated as 0010.

The compressed bitstream length field 22 indicates a data amount of the compressed bitsteam with respect to the line pixel data. The bit shift field 21 and the compressed bitstream length field 22 may be used to determine the image depth of a subsequent line when encoding the subsequent line.

The compressed bitstream field 23 is a playload and indicates the compressed bitstream data.

FIG. 3 is a block diagram illustrating a configuration of an image decoding apparatus according to an embodiment of the present invention.

Referring to FIG. 3, the image decoding apparatus includes a data frame deformatter 31, a decoder 32, a bit shifter 33, and a bit recovery unit 34.

The data frame deformatter 31 may decode a data frame and extract each field value from the decoded data frame. Specifically, the data frame deformatter 31 may extract a field value of each of the bit shift field 21, the compressed bitstream length field 22, and the compressed bitstream field 23 included in the data frame.

The decoder 32 may decode a compressed bitstream included in an extracted single line and recover the line pixel data.

The bit shifter 33 may recover the resolution of the line pixel data. Specifically, the bit shifter 33 may shift, to the left, the line pixel data by the bit shift field value that is extracted from the data frame deformatter 31 and thereby recover the original resolution. For example, when it is assumed that the line pixel data includes five bits and a bit shift field is 0010, the bit shifter 33 may shift the line pixel data two bits to the left. Through this, the bit shifter 33 may output 7-bit line pixel data and thereby recover the resolution of the line pixel data.

The bit recovery unit 34 may recover data that is lost when adjusting the resolution of image encoding. Specifically, the bit recovery unit 34 may obtain a bit value in a location where the data is lost due to the bit adjustment, from a value of previous line pixel data in the same location, and thereby recover the bit value. In this instance, a lower bit value with respect to an average of line pixel data of previous lines may be used as the value of previous line pixel data. Also, a lower bit value of line pixel data of a previous line may be used as the value of previous line pixel data. For example, when the resolution of the 5-bit pixel data is recovered to the resolution of the 7-bit line pixel data by the bit shifter 33, lower two bits of the line pixel data may have a low value of 00 or may have random data. The lower two bits may correspond to the data that is lost when adjusting the resolution of image encoding. Therefore, the lost lower two bits may be recovered using lower two bits with respect to the average of line pixel data of previous lines. Also, the lost lower two bits may be recovered using lower two bits of line pixel data of a previous line.

The image encoding/decoding apparatus according to the present invention may transmit and receive line pixel data for each line. In this instance, the image encoding/decoding apparatus may change a compressed data amount to be transmitted by adjusting the resolution for each line pixel. Specifically, it is possible to uniformly maintain a bit rate of line pixel data with respect to the whole screen by adaptively changing the line pixel data according to channel characteristics. Therefore, according to the present invention, the image encoding/decoding apparatus may improve the deterioration phenomenon of image picture quality that may occur due to the change in the bit rate.

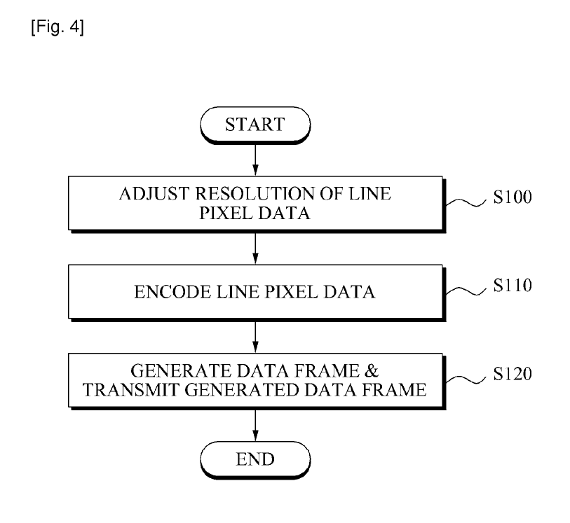

FIG. 4 illustrates an image encoding method according to an embodiment of the present invention.

Referring to FIG. 4, in operation S100, the image encoding method may adjust the resolution of line pixel data of a single line.

According to an aspect of the present invention, the resolution of line pixel data may be adjusted by a bit shifter. Specifically, the bit shifter may shift, to the right, a predetermined number of bits included in the line pixel data based on the image depth and thereby reduce the resolution of the line pixel data. The image depth may be determined by predicting a compressed data amount of a current line based on a compressed data amount of a previous line and a transmission data amount.

In operation S110, the image encoding method may encode the line pixel data with the adjusted resolution.

The line pixel data may be encoded according to a lossless encoding scheme and be output as a compressed bitstream. The lossless encoding scheme may be, for example, a Huffman encoding scheme, but the present invention is not limited thereto. In this instance, the Huffman encoding scheme allocates a relatively short encoded word to frequently appearing input data and allocates a relatively long encoded word to less frequently appearing input data.

In operation S120, the image encoding method may generate a data frame.

The data frame for line pixel data may be generated. The data frame includes a bit shift field, a compressed bitstream length field, and a compressed bitstream field. The data frame may be transmitted via a transmitting end.

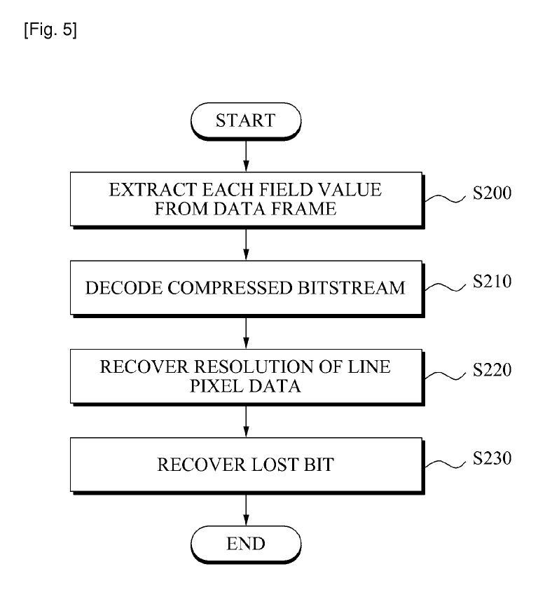

FIG. 5 is a flowchart illustrating an image decoding method according to an embodiment of the present invention.

Referring to FIG. 5, in operation S200, the image decoding method may extract a field value from a received data frame.

The image decoding method may decode the received data frame to extract a field value from each of a bit shift field, a compressed bitstream length field, and a compressed bitstream field.

In operation S210, the image decoding method may decode the compressed bitstream.

The image decoding method may decode the compressed bitstream by referring to the compressed bitstream length field and thereby recover the line pixel data.

In operation S220, the image decoding method may recover the resolution of the line pixel data.

The image decoding method may be aware of an adjustment level of the resolution, that is, a bit adjustment value by referring to the bit shift field and recover the resolution of the line pixel data using the bit adjustment value.

In operation S230, the image decoding method may recover a lost bit value.

Specifically, the image decoding method may obtain a bit value in a location where the data is lost due to the bit adjustment, from a value of previous line pixel data in the same location, and thereby recover the bit value. In this instance, a lower bit with respect to an average of line pixel data of previous lines may be used as the value of previous line pixel data. Also, a lower bit value of line pixel data of a previous line may be used as the value of previous line pixel data.

The above-described image encoding/decoding method may compress image data for each line according to characteristics of a channel and the image data and thereby uniformly maintain a bit rate of the image data. Therefore, the image encoding/decoding method may significantly decrease loss of image data in a radio channel that may change over time.

The exemplary embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

According to the present invention, there is provided an apparatus and method of uniformly maintaining a bit rate of image data that can compress image data for each line according to characteristics of the image data and a channel, and transmit the compressed image data and thereby can uniformly maintain a bit rate of the image data. Therefore, it is possible to improve the deterioration phenomenon of image picture quality.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An image encoding apparatus comprising:
a bit shifter configured to shift a predetermined number of bits included in line pixel data of a single line;
an encoder configured to compress the bit shifted line pixel data and output a compressed bitstream; and
a data frame formatter configured to generate a data frame including a bit shift field, the bit shift field containing information associated with the shifted bit of the pixel data.

2. The image encoding apparatus of claim 1, wherein the data frame further includes a compressed bitstream length field and a compressed bitstream field.

3. The image encoding apparatus of claim 1, further comprising:
a first in first out (FIFO) buffer configured to output the data frame to a transmitting end.

4. The image encoding apparatus of claim 3, wherein the FIFO buffer is configured to determine an image depth based on a bitstream amount of line pixel data of a previous line and a remaining bitstream amount after transmitting the bitstream of the line pixel data of the previous line, and to transfer the determined image depth to the bit shifter.

5. The image encoding apparatus of claim 4, wherein the bit shifter is configured to shift the predetermined number of bits to the right based on the image depth.

6. An image decoding apparatus comprising:
a data frame deformatter configured to receive a data frame and extract a field value from the data frame;
a decoder configured to decode a compressed bitstream from the data frame, and recover line pixel data;
a bit shifter configured to shift a predetermined number of bits included in the line pixel data; and
a bit recovery unit configured to recover a lost bit with respect to an output signal of the bit shifter.

7. The image decoding apparatus of claim 6, wherein the data frame includes a field value of each of a bit shift field, a compressed bitstream length field, and a compressed bitstream field.

8. The image decoding apparatus of claim 7, wherein the bit shifter is configured to shift the predetermined number of bits to the left by the bit shift field value.

9. The image decoding apparatus of claim 6, wherein the bit recovery unit is configured to recover the lost bit based on a lower bit value of previous line pixel data, or based on a lower bit value with respect to an average of the previous line pixel data.

10. A method of encoding an image, the method comprising:
adjusting a resolution of line pixel data of a single line;
compressing the line pixel data with the adjusted resolution to output a compressed bitstream;
generating a data frame including the bitstream; and
transmitting the generated data frame.

11. The method of claim 10, further comprising:
determining an image depth of line pixel data of a subsequent line based on a bitstream amount of the line pixel data of the single line and a remaining bitstream amount after transmitting the data frame.

12. The method of claim 11, wherein a predetermined number of bits included in the line pixel data is shifted to the right based on the depth image to adjust the resolution of the line pixel data.

13. A method of decoding an image, the method comprising:
receiving a data frame to extract a field value from the data frame;
decoding a compressed bitstream from the data frame to recover line pixel data;
recovering a resolution of the line pixel data; and
recovering a lost bit with respect to the line pixel data with the recovered resolution.

14. The method of claim 13, wherein the data frame includes a field value of each of a bit shift field, a compressed bitstream length field, and a compressed bitstream field.

15. The method of claim 14, wherein the resolution is recovered by shifting a predetermined number of the line pixel data to the left by the bit shift field value.
